(19) United States
(12) Patent Application Publication
(10) Pub. No.: US 2015/0106250 A1
(43) Pub. Date: Apr. 16, 2015

(54) COMPUTING SYSTEMS AND COMPUTER-IMPLEMENTED METHODS FOR USE WITH INTEREST RATE SWAP FUTURE INSTRUMENTS

(71) Applicant: THE NASDAQ OMX GROUP, INC., New York, NY (US)

(72) Inventor: Stuart DEEL-SMITH, Middlesex (GB)

(21) Appl. No.: 14/513,903

(22) Filed: Oct. 14, 2014

Related U.S. Application Data
(60) Provisional application No. 61/890,770, filed on Oct. 14, 2013.

(51) Int. Cl. G06Q 40/04

(52) U.S. Cl. CPC G06Q 40/04
USPC 705/37

(57) ABSTRACT

A network architecture may include an exchange computing system, clearinghouse computing system, and trading terminals. The exchange computing system, clearinghouse computing system, and trading terminals may facilitate the trading of contracts in interest rate swap (IRS) futures contracts. The IRS futures contracts may involve the delivery of a “par” IRS (i.e., an IRS where the present value of the fixed leg is equal to the present value of the floating leg). The exchange computing system may receive orders from trading terminals for the IRS futures contracts, and par IRSs may be delivered upon the delivery dates specified by the IRS futures contracts.

### CROSS-REFERENCE TO RELATED APPLICATION(S)

Priority is claimed to U.S. Provisional Patent Application No. 61/890,770, filed on Oct. 14, 2013. The disclosure of the aforementioned priority document is incorporated herein by reference in its entirety.

### BACKGROUND

### Technical Field

The technology herein relates to computer-implemented trading and clearing of derivative interest rate swap future orders received from trading participants, as well as other related subject matter.

### Exchange, Clearinghouse, and Trading Technology

An electronic exchange system is a computing system that allows financial instruments (such as equities, bonds, and derivatives) to be listed for purchase/sale, and which can initiate transactions between market participants for financial instruments. Trading terminals are computing systems used by market participants to interact with electronic exchange systems; a trading terminal may, for example, be used to transmit messages to an electronic exchange system, the messages indicating that the owner of a position in a financial instrument is willing to sell a position in a given financial instrument for a given price. Electronic clearinghouse systems are computing systems that are designed to handle the settling and clearing of transactions that are initiated at an electronic exchange. Significant effort has been spent over the past few decades to develop exchange, clearinghouse, and trading technology that is secure, reliable, and low-latency. For example, many modern electronic exchange systems can process tens of thousands of transactions per second.

### Derivative Contracts

A derivative contract is a contract between two parties that specifies conditions (e.g., dates, resulting values of underlying variables, and amounts) for which payments are to be made between the parties. Some of the common variants of derivative contracts include: (1) a forward, which is a non-standardized contract between two parties where payment takes place at a specific time in the future at a current predetermined price; (2) a future, which is a standardized contract to buy or sell an asset with delivery and/or payment on a specified delivery date at a specified price (e.g., a price set by the parties); (3) an option, which is contract giving the owner the right, but not the obligation, to buy (in the case of a call option) or sell (in the case of a put option) an asset at a “strike” price at a time specified by the option contract; (4) a warrant, which is a long-dated option; (5) and a swap, which is a contract to exchange cash flows on or before a specified future date based on the underlying value of currency exchange rates, bonds, interest rates, commodities, stocks, or other assets. These types of contracts may be combined in various ways—e.g., in a derivative swap futures contract.

Clearing relates to the activities from the time a commitment is made for a contract transaction until it is settled. That clearing time period (the cycle time for completing the transaction) is much longer than the time it takes for the transaction commitment to occur, e.g., a buy-sell match. Clearing itself involves the management of post-trading and pre-settlement credit exposure to ensure that trades are settled in accordance with market rules even if a buyer or seller might become insolvent prior to settlement. Clearing processes include reporting/monitoring, risk margining, netting of trades to single positions, and/or default handling.

Settlement is a process where securities or interests in securities are delivered, usually against (in simultaneous exchange for) payment of money, to fulfill contractual obligations arising under financial instrument trades. For example, the settlement date for marketable stocks might be three business days after the trade is executed, and for listed options and government securities, it might be one day after the execution. As part of performance on the delivery obligations entailed by the trade, settlement involves the delivery of securities and the corresponding payment.

Multiple risks arise for the parties during the settlement time, which are managed by the clearing process. Clearing also typically involves modifying the contractual obligations associated with the trade so as to facilitate settlement. A clearinghouse is a financial entity that provides clearing and settlement services for financial and commodities derivatives and securities transactions. A clearinghouse intercedes between two clearing entities (also known as clearing members) in order to reduce the risk that one (or more) clearing participants fails to honor its trade settlement obligations. A clearinghouse reduces the settlement risks by (1) netting (netting means to allow a positive value and a negative value to set-off and partially or entirely cancel each other out) offsetting transactions between multiple counterparties, (2) requiring collateral or margin deposits, (3) providing independent valuation of trades and collateral, (4) monitoring the credit worthiness of clearing participants, and in many cases, (5) providing a guarantee fund that can be used to cover losses that exceed a defaulting clearing participant's collateral on deposit.

Once a trade is executed by two counterparties, the trade is provided to a clearinghouse which then “steps in” between the two original traders' clearing firms and assumes the legal counterparty risk for the trade. In derivatives trading markets, the clearinghouse interposes between buyers and sellers as a legal counterparty—i.e., the clearinghouse becomes the buyer to every seller and the seller to every buyer. The process of transferring the trade title to the clearinghouse is typically called “novation.” As a result, there is no need for the counterparties to asses the credit worthiness of the opposing party. Rather the credit risk faced by the participants is the risk of a default from by the clearinghouse. Thus, a clearinghouse assumes the risk of settlement failures and also isolates the effects of a failure of a market participant.

### Interest Rate Swaps

As noted above, one type of derivative contract is a swap; one type of swap is an Interest Rate Swap (IRS). In an IRS, the parties to the IRS exchange a stream of interest rate payments. In a typical IRS scenario, the IRS is composed of a “fixed” leg (which is associated with a fixed interest rate) and a “floating” leg (which is associated with a floating/variable interest rate); one party to the IRS is the “fixed rate payer” and will pay at the fixed interest rate to the other party, while the other party is the “floating rate payer” that will pay at the floating rate. The parties to the swap use a “notional principal” (notional because it is not exchanged) amount that is used to determine the future cash flow (e.g., the size and frequency of the payments) for the respective legs of the swap.

At the inception of many IRSs, the total present value (PV) of the stream of payments from the fixed leg of the swap is set so as to be equal to the calculated stream of payments for the floating leg of the swap. In other words, the present value of the income stream for the fixed leg (PV_{FIXED}) and the present value of the income stream for the floating leg (PV_{FLOATING}) are set to be equal. When PV_{FIXED} and PV_{FLOATING} are equal, the IRS is said to be “at par.”

As mentioned, at the inception of many IRSs, the value of the value of fixed rate payments is equal to the value of floating rate payments. However, after inception of the swap the two values will diverge as actual interest rates deviate from those used as a basis for calculating the initial values for PV_{FIXED} and PV_{FLOATING}. As rates move or change, the swap changes value based on the up or down movement of the floating rates, and the IRS will become an asset to one party and a liability to the other. When an IRS deviates from its par value, its value may be expressed in terms of its “non par value,” which is (PV_{FIXED}−PV_{FLOATING}).

The following is a simple example using BigBank and BigFinance to show how an IRS may work in practice. Most of BigBank's assets are fixed rate mortgages that are largely insensitive to fluctuations in interest rates while most of its liabilities (deposits) are sensitive to interest rate changes. In contrast, BigFinance may have assets that are interest rate sensitive while having liabilities that are mostly insensitive to interest rate changes. Given this arrangement, BigBank may want to reduce its exposure to rising interest rates, while Big Finance may want to enter the interest rate market because it believes interest rates will fall (or reduce its exposure to falling interest rates). Accordingly, a swap can be drawn up such that Big Bank receives a floating value stream that is tied prevailing market interest rates, whereas BigFinance receives a constant revenue stream that does not vary (unlike its other assets). Over the duration of the IRS, a number of periodic payments between the parties is made; at each payment, BigBank is obligated to pay BigFinance an amount that is equal to (notional amount×fixed rate) and BigFinance is obligated to pay BigBank an amount that is equal to (notional amount×floating rate). The actual money that is transferred may be offset, based on the respective amounts each party is obligated to pay the other; for example, if BigBank is obligated to pay BigFinance $2 M and BigFinance it obligated to pay BigBank $1 M, then BigBank would tender a payment of only $1 M to BigFinance. Using this IRS, both entities can reduce their exposure due to interest rate changes in the market.

### Interest Rate Swap (IRS) Futures

An interest rate swap future is a financial instrument that has characteristics of both a future and an IRS. With an IRS future, the parties agree that, at a specified future date, an IRS between the parties (the IRS having a set duration) will be initiated. Initiation of the IRS is also referred to as “delivery” of the IRS.

In some scenarios, when an IRS future contract is bought/sold, the interest rate for the fixed leg is set at a predetermined value. As time passes, PV_{FLOATING} may deviate from its initial calculation, thereby changing the value of the IRS future. At the future delivery date (i.e., when the IRS begins), to offset the change in value of the IRS future that has taken place, a cash settlement (which is repaid over the life of the IRS) is made between the buyer and seller. For example: if the value of an IRS future increased $2000 between the date the IRS future was listed and the delivery date of the IRS, then the party receiving fixed rate payments would be obligated to pay $2000 extra to the other party over the life of the IRS, the $2000 being spread out equally across each of the payments.

### SUMMARY

In certain example embodiments, a network architecture is provided, the network architecture including an exchange computing system, clearinghouse computing system, and trading terminals. The exchange computing system, clearinghouse computing system, and trading terminals may facilitate the trading of positions in financial instruments. The financial instruments may include an interest rate swap (IRS) futures contract that involve the delivery of a “par” IRS (i.e., an IRS where the present value for the fixed leg is equal to the present value for the floating leg). The exchange system may receive orders from trading terminals for the IRS futures contract, and par IRSs may be delivered at the delivery dates specified in the contracts.

In certain example embodiments, the exchange computing system, clearinghouse computing system, and/or trading terminals may communicate and/or perform processing relative to a first type of IRS futures contract referred to as a “yield-listed par-deliverable (YLPD) IRS future.” With an YLPD IRS future, contracts may be listed by the exchange computing system in terms of yield (i.e., fixed rate yield), and the fixed rate for the IRS future is not set until delivery of the IRS. After the future is entered into but before its delivery date, the clearinghouse computing system may determine its value and settle profit and loss with respect to the future on a daily basis. On the delivery date of the future, the clearinghouse computing system may set the interest rate for the fixed leg of the IRS, such that the IRS is at par.

In certain example embodiments, the exchange computing system, clearinghouse computing system, and/or trading terminals may communicate and/or perform processing relative a second type of IRS future referred to as a “price-listed par-deliverable (PLPD) IRS future.” When a PLPD IRS futures contract is initially listed by the exchange computing system, the interest rate of the fixed leg of the IRS is set, and the contract is listed according to its price. After the future is entered into but before the delivery date, the clearinghouse computing system determines its value and settles profit and loss with respect to the future on a daily basis. At the delivery date, the clearinghouse computing system sets the interest rate for the fixed leg of the IRS, such that the IRS is at par; the clearinghouse computing system may also adjust the notional amount involved in the IRS to offset the adjustment to the interest rate of the fixed leg.

The features described herein may be combined to form additional embodiments, and sub-elements of certain embodiments may form yet further embodiments.

This Summary is provided to introduce a selection of concepts in a simplified form that are further described below in the Detailed Description. This Summary is intended neither to identify key features or essential features of the claimed subject matter, nor to be used to limit the scope of the claimed subject matter; rather, this Summary is intended to provide an overview of the subject matter described in this document. Accordingly, it will be appreciated that the above-described features are merely examples, and that other features, aspects, and advantages of the subject matter described herein will become apparent from the following Detailed Description, Figures, and Claims.

### BRIEF DESCRIPTION OF THE DRAWINGS

These and other features and advantages will be better and more completely understood by referring to the following detailed description of example non-limiting illustrative embodiments in conjunction with the drawings of which:

FIG. 1 shows an example network architecture wherein the features described herein may be implemented;

FIG. 2 shows an example order book for a yield-listed par-deliverable (YLPD) interest rate swap (IRS) future;

FIG. 3 shows an example order book for a price-listed par-deliverable (PLPD) interest rate swap (IRS) future;

FIG. 4 is shows a method for the trading of IRS futures contracts;

FIG. 5 shows a more specific version of the method of FIG. 4, wherein the IRS futures contracts are YLPD futures contracts;

FIG. 6 shows a more specific version of the method of FIG. 4, wherein the IRS futures contracts are PLPD futures contracts;

FIG. 7 shows further detail regarding an example of how the network architecture of FIG. 1 may be implemented; and

FIG. 8 shows an example computing device that may be used to implement features described herein.

### DETAILED DESCRIPTION

In the following Detailed Description, for purposes of explanation and non-limitation, specific details are set forth, such as particular nodes, functional entities, techniques, protocols, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on non-transitory computer-readable storage medium and when the instructions are executed by a processor, the processor performs the functions. Although databases may be described herein, other formats (including relational databases, object-based models and/or distributed databases) may be used to store and manipulate data.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred. A description of a process is a description of an apparatus for performing the process. The apparatus that performs the process may include, e.g., a processor and those input devices and output devices that are appropriate to perform the process.

Various forms of non-transitory, computer-readable media may be involved in carrying data (e.g., sequences of instructions) to a processor. For example, data may be (i) delivered from RAM to a processor; (ii) carried over any type of transmission medium (e.g., wire, wireless, optical, etc.); (iii) formatted and/or transmitted according to numerous formats, standards or protocols, such as Ethernet (or IEEE 802.3), SAP, ATP, Bluetooth, and TCP/IP, TDMA, CDMA, 3G, etc.; and/or (iv) encrypted to ensure privacy or prevent fraud in any of a variety of ways well known in the art.

Section headings are used throughout this Detailed Description in order to orient the reader to the general subject matter of each section. It should be understood that these headings are not intended to limit the subject matter included in each section; the description of many features spans multiple sections.

### Definitions

“And/or”: As used in this document, the term “and/or” includes any and all combinations of one or more of the associated listed items.

“May”: When it is described in this document that an action “may” be performed, that a feature or component “may” be included in or is applicable to a given context, that a given item “may” possess a given attribute, or whenever any similar phrase involving the term “may” is used, then the given action, feature, component, attribute, etc. is present in at least one embodiment, though is not necessarily present in all embodiments.

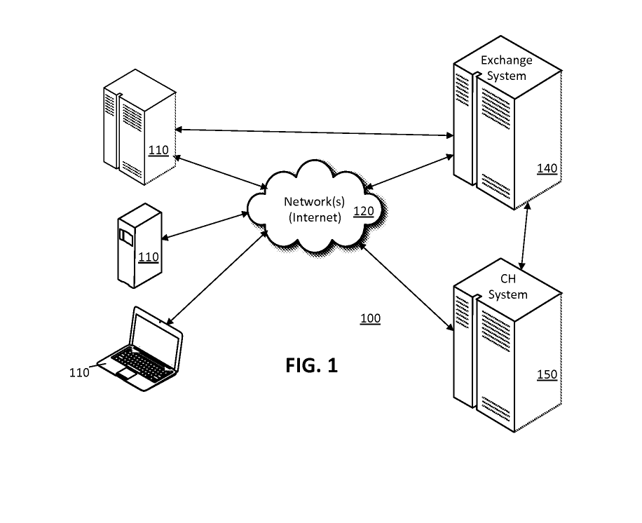

### Description of FIG. 1

By way of introduction, FIG. 1 shows an example network architecture 100 that may include an exchange system 140 (which may also be referred to as an “exchange computing system”), clearinghouse system 150 (or “clearinghouse computing system”), trading terminals 110, and one or more communication networks 120. As will be described in detail below, the network architecture 100 may be used for the trading of (and related activity in) financial instruments, including but not limited to a yield-listed par-deliverable (YLPD) interest rate swap (IRS) future and a price-listed par-deliverable (PLPD) IRS future.

As used herein, the term “exchange” refers to a legal entity that provides a marketplace for financial products; the exchange system 140 is a physical system that comprises computing and networking hardware that is configured (as described in detail below) to implement various functions on behalf of the exchange. Similarly, the term “clearinghouse” refers to a legal entity that provides clearinghouse and settlement services to entities that are members of the clearinghouse; the clearinghouse system 150 is a physical system that comprises computing and networking hardware that is configured (as described in detail below) to implement various functions on behalf of the clearinghouse. Similarly, the trading terminals 110 (which will also be described in detail below) comprise computing and networking hardware and are configured to implement various functions on behalf of entities (such as brokerages, investment firms, banks, and/or other types of institutions) engaged in the trading of financial products. The entities on behalf of which the trading terminals 110 operate may be members of the clearinghouse.

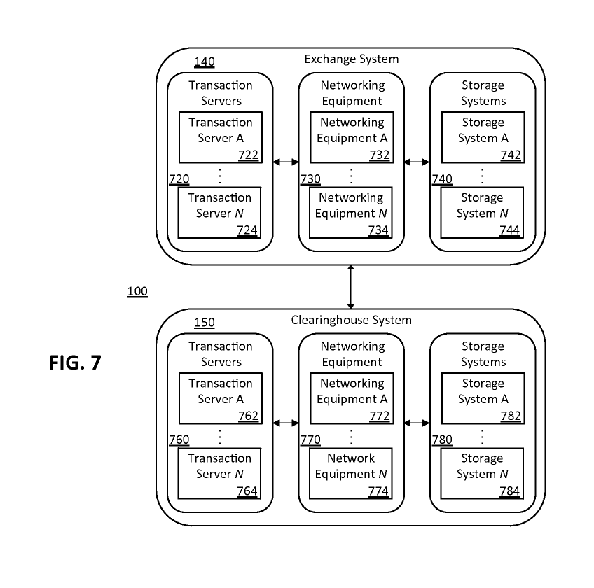

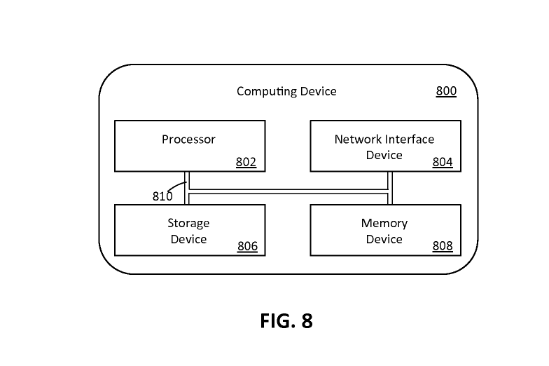

The exchange system 140 and/or the clearinghouse system 150 may be comprised of computing and networking hardware such as: one or more server computers; one or more pieces of networking equipment (e.g., routers/switches); and/or one or more data storage systems (which may implement storage area network (SAN) functionality, network-attached storage (NAS) functionality, and/or similar functionality). These server computers, pieces of networking equipment, and/or data storage systems may each in turn be comprised of components such as one or more processors, one or more network interface devices (e.g., wireless baseband processors and similar components), one or more storage devices (e.g., hard drives), and/or one or more memory devices (e.g., random access memory (RAM) devices). Each or any of the trading terminals 110 may be implemented as, for example, a personal computer, a PDA device, a cell phone, a server computer, and/or any other appropriate system/device able to electronically communicate with the exchange system 140. Each or any of the trading terminals 110 may also be comprised on one or more processors, one or more network interface devices, one or more storage devices, and/or one or more memory devices. When it is described herein that an action is performed by any of these systems 110, 140, 150 it should be understood that the action is performed by the underlying hardware components from which the system 110, 140, 150 is composed; similarly, when it is described herein that any of these systems 110, 140, 150 is configured in a given manner and/or possesses a given attribute, it should be understood that the hardware components from which the system 110, 140, 150 is composed is configured in the given manner and/or possesses the given attribute. Further details regarding the hardware components from which these systems 110, 140, 150 may be composed are provided below, including but not limited to with reference to FIG. 7 and FIG. 8.

The trading terminals 110 are configured to create and place orders for financial instruments with the exchange system 140. As shown in FIG. 1, one or more of the trading terminals 110 may communicate with the exchange system 140 via the one or more communication networks 120 (which may include the Internet). Alternatively or additionally, one or more of the trading terminals 110 may have a dedicated and/or direct connection to the exchange system 140.

The trading terminals 110 may generate/create electronic data messages relating to the placement of orders for purchasing or selling of financial instruments, and transmit the electronic data messages to the exchange system 140. In some instances, one of the trading terminals 110 may receive an order from a user for a financial instrument, and then send a corresponding electronic data message to the exchange system 140; the exchange system 140 may then attempt to match the order. Alternatively or additionally, the trading terminals may include trading terminals that are “algorithmic trading units” (which are also referred to as “automatic order generators”). An algorithmic trading unit may be pre-programmed with instructions to automatically generate sell and buy orders (or changes/cancellations thereof) in response to input data received from the exchange system 140.

An electronic data message that relates to the placement of an order and that is communicated between one of the trading terminals 110 and the exchange system 140 may include various parameters, including: a parameter that indicates whether to buy or sell an instrument (i.e., whether to enter a long order or a sell order); a parameter that indicates a price or yield for the order; a parameter that indicates a quantity associated with the order; and/or a parameter that indicates an account associated with the order.

In some embodiments, the exchange system 140 may maintain an order book (which is a data structure that stores characteristics regarding open limit orders), and may implement a matching engine. The matching engine is a software component that runs on the hardware that comprises the exchange system 140, and that matches new orders with orders in the order book. Upon receiving an electronic data message that indicates an order, the matching engine may attempt to match the received order with a corresponding order in the order book. If the order does not include a match, the exchange system 140 may add the order to the order book. In certain example embodiments, the exchange system 140 can partially match orders in the order book. If the matching engine can match the received order, the exchange system 140 may initiate a trade, and then may communicate with the clearinghouse system 150 regarding the trade.

The exchange system 140 may “list” a financial instrument; this means that the exchange system 140 may facilitate trading in contracts for the instrument, by (a) receiving orders for and maintaining an order book relative to the instrument (as described above), and (b) communicating information regarding open orders (via electronic data messages) to the trading terminals 110. When the exchange system 140 is described herein as listing an instrument in terms of price, that means that one or more of the following may apply: the orders received by the exchange system 140 indicate prices; the exchange system 140 maintains price information for the orders in the order book; the matching of orders (as performed by the matching engine) include the matching of orders by price; and the exchange system 140 communicates order book information (that may include information regarding the prices of current offers for instruments, including but not limited to the best long offer and best short offer for the instrument) to the trading terminals 110. Similarly, when the exchange system 140 lists an instrument in terms of some other factor (such as yield), the exchange system 140 may perform the same or analogous actions, mutatis mutandis, described above with respect to price.

The clearinghouse system 150 may process data related to trades initiated at the exchange system 140, and may also maintain account (and/or “portfolio”) information for members of the clearinghouse. The clearinghouse with which the clearinghouse system 150 is associated may, for example, have several counterparties, and each counterparty may have one or more accounts. In each account, information regarding trades is accumulated. When processing data related to a trade, the clearinghouse system 150 may update the account(s) associated with the trade with information regarding the trade, and/or information regarding the “positions” involved in the trade (i.e., the number of long and/or short contracts in a particular instrument) may be added to the account(s).

The following is a simplified example of some aspects of how a trade may be performed in the network architecture 100 of FIG. 1:

(a) one of the trading terminals 110 sends an electronic data message to the exchange system 140, the electronic data message indicating an order from a first market participant (BigFinance) to sell ten contracts in a derivative financial instrument;

(b) another of the trading terminals 110 sends an electronic data message to the exchange system, the electronic data message indicating a corresponding buy order from a second market participant (BigBank) for ten contracts in the derivative financial instrument;

(c) the exchange system 140 receives the electronic data messages, processes the orders (using the matching engine), and then initiates the trade;

(d) the exchange system 140 communicates with the clearinghouse system 150 for clearing and settlement of the trade;

(e) the clearinghouse system 150 then generates derivative positions for BigBank and BigFinance; at this point, BigBank has a +10 (long) position in the instrument and BigFinance has a −10 (short) position in the instrument.

Communication between the exchange system 140 and the clearinghouse system 150 may take place via the one or more networks 120; alternatively or additionally, communication between the exchange system 140 and the clearinghouse system 150 may take place via a dedicated and/or direct connection.

The one or more communication networks 120 may include one or more wireless networks, one or more wired networks, and/or may include the Internet. The one or more communication networks may be based on packet-switched technology. Alternatively or additionally, the one or more networks may be based on technology that includes: Ethernet technology; fiber optics technology; microwave technology; laser technology; xDSL (Digital Subscriber Line) technology; Wireless Local Area Network (WLAN) technology (i.e., IEEE 802.11x technology); and/or wireless cellular technology (e.g., Long Term Evolution (LTE), LTE-Advanced (LTE-A), and/or 3G cellular technology). Whenever it is described herein that an electronic data message is communicated from a first endpoint to a second endpoint via the one or more networks 120, it should be understood that the following may occur: the electronic data message may be communicated out to a first network from the one or more networks 120 to which the first endpoint is connected (e.g., if the first endpoint is connected to a WLAN, the electronic data message will be communicated to the WLAN); the electronic data message may then be routed (by a router) out of the first network and to (via one or more intermediate networks from the one or more networks 120, where the intermediate networks may, in some instances, include the Internet); the electronic data message may then ultimately be delivered to a router in a second network from the one or more networks 120 to which the second endpoint is connected, and delivered by the router to the second endpoint via the second network. As noted above, the trading terminals 110 and the exchange system 140 may communicate via a direct and/or dedicated connection, and that communication between the exchange system 140 and the clearinghouse system 150 may take place via a dedicated and/or direct connection; when endpoints are described herein as communicating via a dedicated and/or direct connection, that means that they may be connected to the same network (which network may based on one or more of the technologies (Ethernet, fiber optics, etc.) mentioned above) or be connected in a direct peer-to-peer manner.

Although not shown in FIG. 1, the network architecture 100 of FIG. 1 may include an entry gateway, via which the trader terminals 110 may connect to the exchange system 140. The entry gateway may be connected to, or may be part of, the exchange system 140, and may be configured to receive orders from the trader terminals 110. The entry gateway may connect with the exchange system 140 on a dedicated network, may forward the market actions to the exchange system 140, and may further broadcast updates back to the trader terminals 110.

Although not shown in FIG. 1, the network architecture 100 of FIG. 1 may also include one or more market data feed servers. The market data feed servers may provide one or more data services to the exchange system 140 and/or the clearinghouse system 150. Per these services, the exchange system 140 and/or the clearinghouse system 150 may receive electronic data messages from the market data feed services via the communication networks 120; the electronic data messages may include market information. The market information may include information such as: current overnight indexed swap (OIS) rates; current benchmark prices for interest rate futures, such as sterling futures, euro (EURIBOR) futures, and/or eurodollar (LIBOR) futures; and/or other information. The market data feed servers may be operated on behalf of entities such as WM/Reuters, Bloomberg, and/or other appropriate entities. Whenever it is described herein that the exchange system 140 and/or the clearinghouse system 150 receive, process, and/or otherwise handle market information, the exchange system 140 and/or the clearinghouse system 150 may receive such data from the market data feed servers per these services.

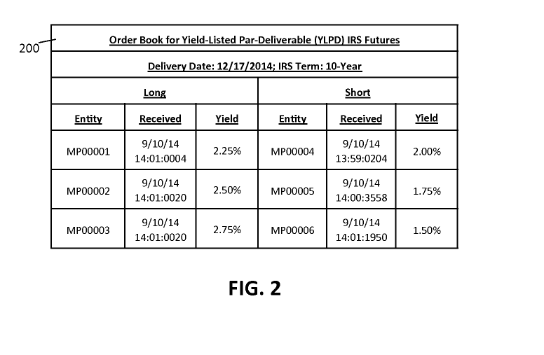

### Description of the YLPD IRS Future and FIG. 2

In certain example embodiments, the network architecture 100 of FIG. 1 may be used for the trading of positions in the yield-listed par-deliverable (YLPD) interest rate swap (IRS) future. A YLDP IRS futures contract is an IRS futures contract that is listed in terms of yield, and where the interest rate for the fixed leg is not set until the IRS is delivered. With a YLPD IRS future, the “buyer” of the contract (i.e., the entity taking the “long” position in the contract) will receive payments under the IRS at the fixed rate and make payments at the floating rate; the “seller” of the contract (i.e., the entity taking the “short” position on the contract) will receive payments under the IRS at the floating rate and make payments at the fixed rate.

As noted, the exchange system 140 may list YLPD IRS futures contracts in terms of “yield”; the term “yield” as used herein refers to the effective rate received by a buyer of the contract. After a contract is bought/sold but before the delivery date, the clearinghouse system 150 may perform periodic (e.g., daily) profit and loss calculations relative to the contract; the profit/loss calculations may be based on factors such as the yield at which the contract was entered (i.e., the “contract yield”), a current benchmark market yield for the YLPD IRS future (which may be, for example, a yield at which the YLPD IRS future recently traded on the exchange system 140), the length of time (e.g., number of days) until the delivery date, and/or other factors.

At the delivery date, the clearinghouse system 150 may receive one or more electronic data messages from the exchange system 140, the one or more electronic data messages including the current benchmark yield for the YLPD IRS future. (Again, the current benchmark yield may be, as one example, a yield at which the YLPD IRS future recently traded on the exchange system 140). The clearinghouse system 150 may set the fixed rate for the IRS to be the same as the current benchmark yield, thereby delivering an IRS at par value. It should be noted that fixed rate set for the IRS here may (in many instances) be different than the contract yield; this difference is offset by the profit/loss that is accounted for before the delivery date. In other words, the yield for a YLPD IRS futures contract may be seen as a rate that is reflective of (a) profit/loss that will be credited/debited to/from the buyer between the purchase of the contract and the delivery date and (b) the fixed rate that will be received by the buyer during the life of the IRS.

Referring now to FIG. 2, FIG. 2 shows example order book information that the exchange system 140 may maintain for trading of YLPD futures contracts. FIG. 2 shows an example order book table 200 (which is entitled “Order Book for Yield-Listed Par-Deliverable (YLPD) IRS Futures”); as shown in FIG. 2, the example order book table 200 relates to offers for YLPD IRS futures contracts where the future has an delivery date of Dec. 17, 2014 and where the IRS has a ten-year term. In the “Long” area, the example order book table 200 includes a number of example offers for long contracts; the “Short” area includes a number of example offers for short contracts. In the “Long” area, the top-most example order has the following characteristics: it was received from a market participant with the unique identifier “MP00001”; it was received by the exchange system 140 on Sep. 10, 2014 at 14:01:0004; and the yield indicated by the order is 2.25%. In other words, this example order indicates that market participant MP00001 is willing to enter into a YLPD IRS futures contract where they will make payments under the IRS at the floating rate and receive a yield of 2.25% or better.

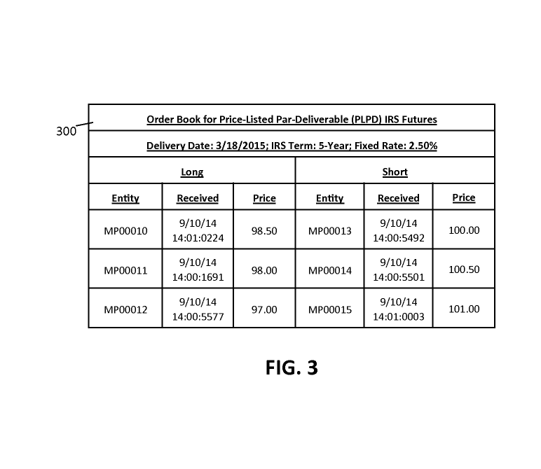

### Description of the PLPD IRS Future and FIG. 3

In certain example embodiments, the network architecture 100 of FIG. 1 may be used for the trading of positions in the PLPD IRS future. A PLPD IRS futures contract is an IRS futures contract, where the contract is listed in terms of price, and where the interest rate for the fixed leg may be set to an initial predetermined fixed rate, per the contract specification. At delivery of the IRS, the clearinghouse system 150 adjusts the fixed rate of the IRS, such that a par IRS is delivered. As with the YLPD IRS future, the buyer of a PLPD IRS contract will receive payments under the IRS at the fixed rate and make payments at the floating rate, and the seller of the contract will receive payments under the IRS at the floating rate and make payments at the fixed rate.

As noted, the exchange system 140 may list the PLPD IRS future in terms of price. With the PLPD IRS future, a price of “100” indicates par value (i.e., that PV_{FIXED} and PV_{FLOATING} are equal). The price may also be thought of as (PV_{FIXED}−PV_{FLOATING}); therefore, prices that are different from 100 indicate a variation off of par value in terms of the net present value of the contract. For example, if a market participant is willing to buy a PLPD IRS futures contract at a price of 102.00 (recall that the buyer receives payments under the IRS at the fixed rate and pays at the floating rate), that may indicate that the market participant believes that the payments they will receive under the IRS at the fixed rate (which will be based on the initial fixed rate for the contract) will be greater than what they will pay under the IRS at the floating rate, and so they are willing to pay over par for the contract.

After an PLPD IRS futures contract is entered into but before the delivery date, the clearinghouse system 150 may perform periodic (e.g., daily) profit and loss calculations relative to the contract; the profit/loss calculations may be based on factors such as the price at which the contract was bought/sold (i.e., the “contract price”), a current benchmark market price for the PLPD IRS future, the length of time (e.g., number of days) until the delivery date, and/or other factors.

At the delivery date for the PLPD IRS futures contract, the clearinghouse system 150 may perform the following: the clearinghouse system 150 may receive market information such as current overnight indexed swap (OIS) rates and/or current benchmark prices for interest rate futures; the clearinghouse system 150 may determine PV_{FLOATING} for the IRS, based on the market information (as benchmark prices for interest rate futures may be indicative of future interest rates, the prices for interest rate futures may be used to model PV_{FLOATING}); the clearinghouse system 150 may determine an adjusted fixed rate for the IRS, such that PV_{FIXED} (using the adjusted fixed rate) is equivalent to the determined PV_{FLOATING}; and the clearinghouse system 150 may adjust the notional amount for the IRS, to offset against the adjustment of the fixed rate.

Referring now to FIG. 3, FIG. 3 shows example order book information that the exchange system 140 may maintain for trading of PLPD futures contracts. FIG. 3 shows an example order book table 300 (which is entitled “Order Book for Price-Listed Par-Deliverable (PLPD) IRS Futures”); as shown in FIG. 3, the example order book table 300 relates to offers for PLPD IRS futures contracts where the future has an delivery date of Mar. 18, 2015, the IRS has a five-year term, and the initial fixed rate for the IRS is 2.50%. In the “Long” area, the example order book table 300 includes a number of example offers for long contracts; the “Short” area includes a number of example offers for short contracts. In the “Long” area, the top-most example order has the following characteristics: it was received from a market participant with the unique identifier “MP00010”; it was received by the exchange system 140 on Sep. 10, 2014 at 14:01:0224; and the yield indicated by the order 2.00%. In other words, this example order indicates that market participant MP00010 is willing to enter into a PLPD IRS futures contract at 98.50 or better, where they will make payments under the IRS at the floating rate and receive payments under the IRS at the fixed rate, which the clearinghouse system 150 will determine at the delivery date of the future.

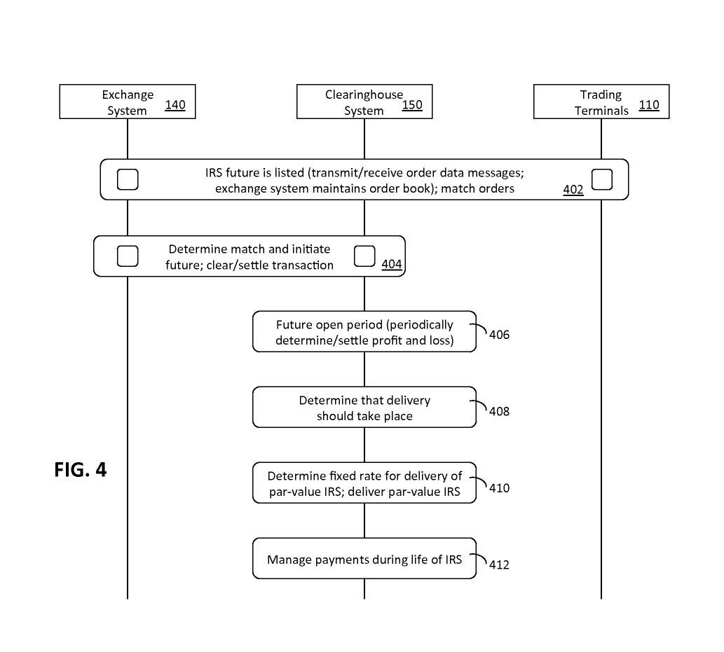

### Description of FIG. 4

FIG. 4 shows a method for the trading of (and other activity related to) IRS futures contracts that involve the delivery of an IRS at par value. The method of FIG. 4 may be used with the YLPD IRS future, the PLPD future, and/or any other appropriate type of IRS future. FIG. 4 shows the exchange system 140, clearinghouse system 150, and trading system 110.

The method of FIG. 4 may begin with operation 402, where the IRS future is listed by the exchange system 140. This may include one or more of the following: (a) the trading terminals 110 may transmit electronic data messages to the exchange system 140, the electronic data messages indicating orders for IRS futures contracts and including parameters that include information such as price/yield; (b) the exchange system 140 may receive and process the electronic data messages from the trading terminals 110; (c) the exchange system 140 may maintain an order book based on the electronic data messages; this may include storing information regarding the orders indicated in the received order messages, the information including, for each of the orders: a unique identifier for the market participant that originated the order; a time at which the order was received by the exchange system 140; the type of contract with which the order is associated (e.g., a contract for a YLPD IRS futures contract); the delivery date associated with the contracts; a yield or price associated with the order; and/or other information; (d) the exchange system 140 may transmit electronic data messages to the trading terminals 110 regarding the contents of the order book, where the electronic data messages include information such as the prices/yields of current offers, including but not limited to the current best long offer and current best short offer.

Operation 402 may also include the matching engine implemented by the exchange system 140 performing analysis of received orders against the order book in order to determine matches. In an embodiment where the exchange system 140 receives orders regarding YLPD IRS futures contracts, operation 402 may include actions such as comparing the values of yield parameters from the received long orders to the values of yield parameters from the received short order, to determine whether the values are equal; in an instance where the exchange system 140 determines that are long order and short order indicate the same yield, the exchange system 140 determines that the orders are a match. In an embodiment where the exchange system 140 receives orders regarding PLPD IRS futures contracts, the exchange system 140 may perform analogous processing, but may compare price parameter values instead of yield parameter values.

At operation 404, the exchange system 140 may determine that two orders (received at operation 402) match, and may initiate a transaction based on the match, thereby initiate the future component of the IRS futures contract. As mentioned above with respect to operation 402, to determine that two orders match, the exchange system 140 may perform analysis that compares the price/yield for a long order for the IRS future against the price/yield for a sell order for the IRS future. After the exchange system 140 determines that two orders match, the exchange system 140 may communicate with the clearinghouse system 150 to finalize the transaction. This may include the exchange system 140 transmitting one or more electronic data messages to the clearinghouse system 150, the one or more electronic data messages including information such as: information that identifies the two parties/market participants involved in the contract (e.g., a unique identifier for the first party to the contract and unique identifier for the second party to the contract); which of the parties holds the long position and which holds the short position; information indicating the delivery date for the contract (i.e., the date on which the IRS will begin); information that identifies the type of the contract; information regarding the yield/price involved in the contract (as matched by the matching engine); and/or other information. The clearinghouse system 150 may store this information upon receiving it.

Additionally, operation 404 may include the clearinghouse system 150 performing one or more actions to clear and settle the transaction. This may include the clearinghouse system 150 updating information for the accounts of the parties involved in the transaction to indicate that the transaction has been cleared and settled.

Further, operation 404 may include the clearinghouse system 150 performing one or more actions to indicate that the future component of the IRS futures contract has begun. This may include the clearinghouse system 150 updating information for the accounts of the parties involved in the transaction to indicate that the future has begun, and/or updating one or more other data structures that include information regarding the future.

At operation 406, the clearinghouse system 150 may perform actions related to the open segment of the future that is part of the IRS futures contract. This may include periodically (e.g., on a daily, weekly, or monthly basis) determining profit and loss for the contract. The clearinghouse system 150 may determine profit/loss calculations based on factors such as the contract yield/price, a current benchmark market yield/price for the IRS future, the length of time (e.g., number of days) until the delivery date, and/or other factors. The exchange system 140 may determine the current benchmark yield/price based on market activity at the exchange system 140; and the clearinghouse system 150 may receive information regarding the current benchmark yield/price from the exchange system 140 in one or more electronic data messages. After determining the profit/loss, the clearinghouse system 150 may: increase/decrease the account value of the account of the buyer according to the determined amount of profit/loss (as appropriate); and increase/decrease the account value of the account of the seller according to the determined amount of profit/loss (as appropriate).

At operation 408, the clearinghouse system 150 may determine that delivery of the IRS should take place. This may include the clearinghouse system 150 determining the current date and comparing the current date against the delivery date for the contract (as indicated in the data received at and initially stored by the clearinghouse system 150 at operation 404).

At operation 410, the clearinghouse system 150 may determine the fixed rate for delivery of the IRS component of the IRS future, such that an IRS at par value is delivered. This may additionally include the clearinghouse system 150 storing information that indicates that the IRS has been delivered/initiated, and/or that indicates the determined fixed rate for the IRS.

At operation 412, the clearinghouse system 150 may manage payments between the parties to the IRS during the life of the IRS. This may include actions such as, at each payment event that takes place during the IRS: determining a current floating rate for the IRS (based on e.g. market information received via one or more data feed services); calculating the product of the notional amount of the IRS and the determined floating rate to arrive at a floating payment amount; calculating the product of the notional amount of the IRS and the fixed rate for the IRS to arrive at a fixed payment amount; and debiting and crediting the accounts of the buyer and seller according to the floating payment amount and fixed payment amount.

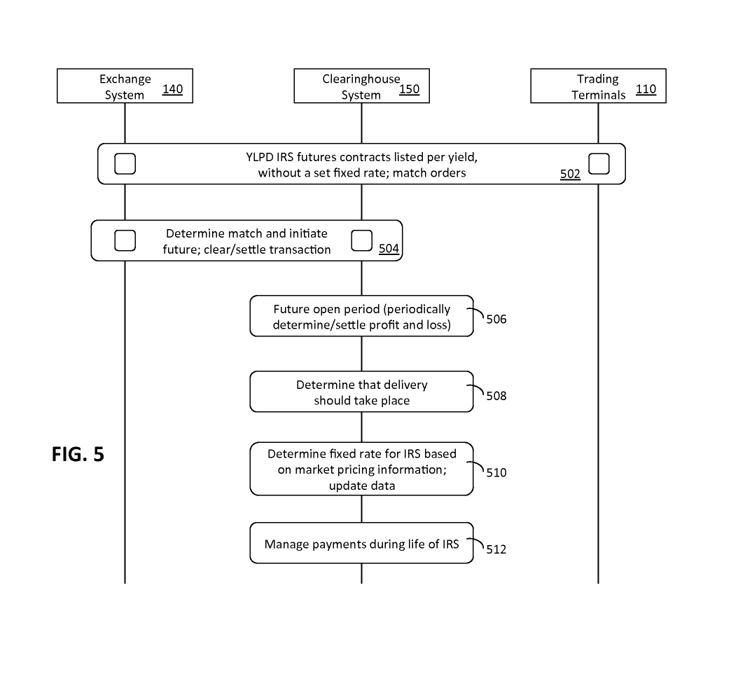

### Description of FIG. 5

FIG. 5 shows a method for the trading of (and other activity related to) YLDP IRS futures contracts. FIG. 5 may be seen as a more specific variation of the method shown in FIG. 4 and described above. As with FIG. 4, FIG. 5 shows the exchange system 140, clearinghouse system 150, and trading system 110.

The method of FIG. 5 may begin with operation 502, which is followed by operation 504. Operation 502 and operation 504 may be performed in the same or in an analogous fashion as described above with reference to the corresponding operations (operation 402 and operation 404) from FIG. 4, with the subject of operation 502 and operation 504 being YLPD IRS futures contracts. This means that e.g. (a) the electronic data messages described with reference to operation 402 may include yield information regarding YLPD IRS futures contracts, and (b) the matching of orders performed by the exchange system 140 with reference to operation 402 and 404 may include matching based on yield.

At operation 506, the clearinghouse system 150 may perform actions related to the open segment of the future that is part of the IRS futures contract, and these actions may include periodically (e.g., on a daily basis) determining profit and loss for the contract. This may be performed in the same or in an analogous fashion as described above with reference to the corresponding operation (operation 406) of FIG. 4. Alternatively or additionally, when the clearinghouse system 150 performs the profit and loss calculations/settlements relative to the contract per operation 506, they may be performed as follows:

(a) the profit/loss calculations may be based on factors such as the contract yield, a current benchmark market yield for the YLPD IRS future (which may be, for example, a yield at which the YLPD IRS future recently traded on the exchange system 140, a yield for the current best short offer for the YLPD IRS future in the order book maintained by the exchange system 140, or a yield for the current best long offer for the YLPD IRS future in the order book maintained by the exchange system 140), the length of time (e.g., number of days) until the delivery date, and/or other factors; and

(b) generally, if the current benchmark market yield for the YLPD IRS future is lower than the contract yield, then profit will be credited by the clearinghouse system 150 to the account of the buyer and corresponding loss will be debited by the clearinghouse system from 150 the account of the seller; and if the current benchmark yield is higher than the contract yield, then loss will be debited by the clearinghouse system 150 from the account of the buyer and corresponding profit will be credited to the account of the seller.

At operation 508, the clearinghouse system 150 may determine that delivery of the IRS should take place. This may be performed in the same or in an analogous fashion as described above with reference to the corresponding operation (operation 408) of FIG. 4.

At operation 510, the clearinghouse system 150 may determine the fixed rate for delivery of the IRS component of the IRS future. This may be performed in the same or in an analogous fashion as described above with reference to the corresponding operation (operation 410) of FIG. 4. Alternatively or additionally, this many include the following:

(a) the clearinghouse system 150 may receive one or more electronic data messages from the exchange system 140, the one or more electronic data messages including a current benchmark yield for the YLPD IRS future (the current benchmark yield may indicate one or more of the types of information as noted above with reference to operation 506);

(b) the clearinghouse system 150 may set the fixed rate for the IRS future to be equal to the current benchmark yield; and

(c) the clearinghouse system 150 may store information that indicates that the IRS has been delivered/initiated, and that indicates the determined fixed rate for the IRS.

Operation 512 may be performed in the same or in an analogous fashion as described above with reference to the corresponding operation (operation 412) from FIG. 4, with the subject of operation 512 being the YLPD IRS futures contract.

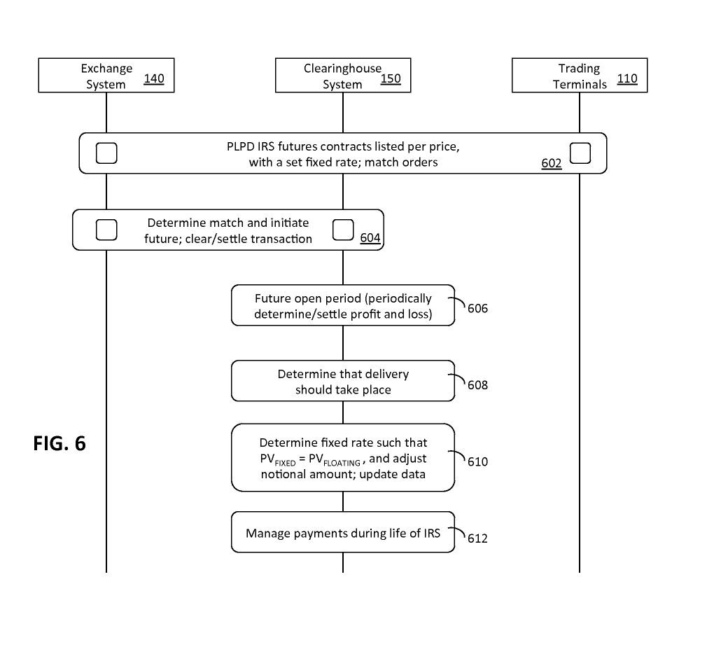

### Description of FIG. 6

FIG. 6 shows a method for the trading of (and other activity related to) PLDP IRS futures contracts. FIG. 6 may be seen as a more specific variation of the method shown in FIG. 4 and described above. As with FIG. 4, FIG. 6 shows the exchange system 140, clearinghouse system 150, and trading system 110.

The method of FIG. 6 may begin with operation 602, which is followed by operation 604. Operation 602 and operation 604 may be performed in the same or in an analogous fashion as described above with reference to the corresponding operations (operation 402 and operation 404) from FIG. 4, with the subject of operation 602 and operation 604 being PLPD IRS futures contracts. This means e.g. that (a) the electronic data messages described with reference to operation 402 may include price information regarding PLPD IRS futures contracts, (b) that the initial fixed rate for the IRS futures contracts may be set to a predetermined value, and (c) the matching of orders performed by the exchange system 140 at operation 604 may include matching based on price.

At operation 606, the clearinghouse system 150 may perform actions related to the open segment of the future that is part of the IRS futures contract, and these actions may include periodically (e.g., on a daily basis) determining profit and loss for the contract. This may be performed in the same or in an analogous fashion as described above with reference to the corresponding operation (operation 406) of FIG. 4. Alternatively or additionally, when the clearinghouse system 150 performs the profit and loss calculations/settlements relative to the contract per operation 606, they may be performed as follows

(a) the profit/loss calculations may be based on factors such as the contract price, a current benchmark market price for the PLPD IRS future (which may be, for example, a price at which the PLPD IRS future recently traded on the exchange system 140, a price for the current best short offer for the PLPD IRS future in the order book maintained by the exchange system 140, or a price for the current best long offer for the PLPD IRS future in the order book maintained by the exchange system 140), the length of time (e.g., number of days) until the delivery date, and/or other factors; and

(b) generally, if the current benchmark market price for the PLPD IRS future is greater than the contract price, then profit will be credited by the clearinghouse system 150 to the account of the buyer and corresponding loss will be debited by the clearinghouse system from 150 the account of the seller; and if the current benchmark price is lower than the contract price, then loss will be debited by the clearinghouse system 150 from the account of the buyer and corresponding profit will be credited to the account of the seller.

At operation 608, the clearinghouse system 150 may determine that delivery of the IRS should take place. This may be performed in the same or in an analogous fashion as described above with reference to the corresponding operation (operation 408) of FIG. 4.

At operation 610, the clearinghouse system 150 may determine the fixed rate for delivery of the IRS component of the IRS future. This may be performed in the same or in an analogous fashion as described above with reference to the corresponding operation (operation 410) of FIG. 4. Alternatively or additionally, this many include the following:

(a) the clearinghouse system 150 may receive market information (such as current OIS rates and/or current benchmark prices for interest rate futures (e.g., sterling futures, euro (EURIBOR) futures, and/or eurodollar (LIBOR) futures) via one or more data feed services, and determine PV_{FLOATING} for the IRS based on the market information;

(b) the clearinghouse system 150 may determine an adjusted fixed rate for the IRS, such PV_{FIXED} is equivalent to PV_{FLOATING} as determined in (a);

(c) the clearinghouse system 150 may adjust the notional amount for the IRS, to offset against the adjustment of the fixed rate; and

(d) the clearinghouse system 150 may store information that indicates that the IRS has been delivered/initiated, and that indicates the adjusted fixed rate for the IRS and the adjusted notional amount for the IRS.

Operation 612 may be performed in the same or in an analogous fashion as described above with reference to the corresponding operation (operation 412) from FIG. 4, with the subject of operation 612 being the PLPD IRS futures contract.

### Description of FIG. 7 and FIG. 8

FIG. 7 shows another view of the network architecture 100 of FIG. 1, highlighting one example of how the exchange system 140 and/or the clearinghouse system 150 may be implemented.

As shown in FIG. 7, the exchange system 140 may include transaction servers 720 (which may include any number of transaction servers, including Transaction Server A 722 through Transaction Server N 724), networking equipment 730 (which may include any number of networking equipment items, including Networking Equipment A 732 through Networking Equipment N 734), and storage systems 740 (which may include any number of storage systems, including Storage System A 742 through Storage System N 744).

The transaction servers 720 may include components such as: one or more blade servers; one or more rack servers; one or more high-performance server computers; one or more computer clusters; and/or other types of high-performance computing equipment.

The networking equipment 730 may include equipment such as: one or more routers; one or more switches; one or more wireless access points; one or more dynamic host control protocol (DHCP) and/or domain name service (DNS) servers; and/or other types of networking equipment.

The storage systems 740 may be storage systems that are designed for “big data” or “data warehousing” purposes, and/or may include one or more rack server computers (referred to sometimes as “data warehouse appliances” or “big data appliances”) designed for use in datacenters. Each or any of the storage systems 740 may include components such as high-performance flash arrays, high-performance solid-state storage devices, and/or other appropriate components. Alternatively or additionally, each or any of the storage systems 740 may implement technologies such as: storage area networking (SAN) protocols; network-attached storage (SAN) protocols; redundant array of independent disks (RAID) technology; storage virtualization technology; a relational database management system (RDBMS); an object-oriented database management system (OODBMS); an object-relational database management system (ORDBMS); a not-only structured query language (NoSQL) data store; an object cache; a distributed file system and clustering technology (such as Hadoop); and/or any other appropriate technology.

Referring now to FIG. 8, FIG. 8 shows an example computing device 800 that may be used to implement features described herein. The computing device 800 includes a number of components, including a processor 802, network interface device 804, storage device 806, memory device 808, and one or more system buses 810.

The processor 802 may be or include a single- or multi-core general purpose processor (using e.g. a Complex Instruction Set Computing (CISC) or Reduced Instruction Set Computing (RISC) architecture), a special purpose processor, a digital signal processor (DSP), one or more microprocessors in association with a DSP core, a controller, a microcontroller, one or more Application Specific Integrated Circuits (ASICs), one or more Field Programmable Gate Array (FPGA) circuits, a system-on-a-chip (SOC), and/or any other type of processing circuitry. Alternatively or additionally, the processor 802 may include circuitry such as one or more of: one or more arithmetic logic units (ALUs); one or more floating point units (FPUs); registers (which may include general purpose and specific-purpose registers); a clock circuit; and/or an instruction decoding unit.

The network interface device 804 may be or include, for example, a baseband processor, a wired or wireless transceiver, a network card, circuitry configured to implement physical layer and data link layer functionality (per the OSI model); and/or any other type of circuitry for implementing networking and/or similar functionality. The network interface device 804 may implement technologies such as Ethernet, fiber optics, microwave, xDSL (Digital Subscriber Line), Wireless Local Area Network (WLAN) technology (i.e., IEEE 802.11 technology), wireless cellular technology (e.g., Long Term Evolution (LTE), LTE-Advanced (LTE-A), and/or 3G cellular technology), and/or any other appropriate wireless or wireless networking technology.

The storage device 806 may be or include a hard disk, a flash disk, an SSD-based disk, a magneto-optical medium, an optical medium (such as a CD-ROM, DVD, or Blu-Ray disc), or other type of device for electronic data storage.

The memory device 808 may be or include a device such as a Dynamic Random Access Memory (D-RAM), Static RAM (S-RAM), and/or other type of RAM.

Communication between the processor 802, network interface device 804, storage device 806, and memory device 808 may be accomplished via the one or more system buses 810.

Although FIG. 8 shows that the computing device 800 includes a single processor 802, network interface device 804, storage device 806, and memory device 808, the computing device 800 may be configured to include more than one of each or any combination of these devices 802, 804, 806, 808 (i.e., at least one of each or any combination of these devices 802, 804, 806, 808), each of the more than one devices possessing attributes identical or similar to those described above with reference to the respective single processor 802, network interface device 804, storage device 806, and memory device 808.

One or more of the components of the exchange system 140 (i.e., one or more of the transactions servers 720, items of the networking equipment 730, and/or storage systems 740) may be implemented using the computing device 800 of FIG. 8.

As noted, when it is described herein that the exchange system 140 may perform an action, it should be understood that the action may in turn be performed by the hardware components from which the exchange system 140 is composed; similarly, when it is described herein the exchange system 140 is configured in a given manner and/or possesses a given attribute, it should be understood that the hardware components from which the exchange system 140 is composed are configured in the given manner and/or possesses the given attribute. To further elaborate on this, in various embodiments, one or more of the following may apply:

(a) When it is described herein that the exchange system 140 may perform an action, the action may be performed by one or more of the transaction servers 720 or by one or more of the transaction servers 720 in conjunction with the networking equipment 730, and/or storage systems 740. In an embodiment wherein one or more of the transaction servers 720 is implemented as the computing device 800 of FIG. 8, any action described herein as performed by the exchange system 140 may in turn be performed by the processor 802 or by the processor 802 in conjunction with the network interface device 804, the storage device 806, and/or the memory device 808, as appropriate.

(b) Whenever it is described herein that the exchange system 140 handles, stores, analyzes, or otherwise processes data of any kind, the data may be handled, stored, analyzed, or otherwise processed by one or more of the transaction servers 720. In an embodiment where one or more of the transaction servers 720 is implemented as the computing device 800, any data that is handled, stored, analyzed, or otherwise processed by one or more of the transaction servers 720 may in turn be handled, stored, analyzed, or otherwise processed by the processor 802 or by the processor 802 in conjunction with the network interface device 804, the storage device 806, and/or the memory device 808, as appropriate.

(c) Whenever it is described herein that the exchange system 140 transmits or receives data of any kind, the data may be transmitted/received by one or more of the transaction servers 720, in conjunction with the networking equipment 730; and in an embodiment where one or more of the transaction servers 720 is implemented as the computing device 800, the data may be transmitted/received by the computing device 800 via the network interface device 804 in conjunction with the processor 802, as appropriate.

(d) In an embodiment where one or more of the transaction servers 720 is implemented as the computing device 800, the storage device 806 and/or the memory device 808 may store instructions which, when executed by the processor 802: (i) cause the processor 802 to perform any action or combination of actions described herein as performed by the exchange system 80; or (ii) cause the processor 802 to perform any action or combination of actions described herein as performed by the exchange system 80, in conjunction with the network interface device 804, storage device 806, and/or memory device 808, as appropriate.

(e) Whenever it is described herein that the exchange system 140 handles, stores, analyzes, or otherwise processes data of any kind, the data may be stored by one or more of the storage systems 740.

The clearinghouse system 150 may include one or more transaction servers 760 (which may include any number of transaction servers, including Transaction Server A 762 through Transaction Server N 764), networking equipment 770 (which may include any number of networking equipment items, including Networking Equipment A 772 through Networking Equipment N 774), and storage systems 780 (which may include any number of storage systems, including Storage System A 782 through Storage System N 784). These components 760, 762, 764, 770, 772, 774, 780, 782, 784 of the clearinghouse system 750 may possess the same and/or similar attributes as the respective corresponding elements 720, 722, 724, 730, 732, 734, 740, 742, 744 of the exchange system 140 described above. Alternatively or additionally, one or more of the components of the clearinghouse system 150 (i.e., one or more of the transaction servers 760, items of networking equipment 770, and/or storage systems 780) may be implemented using the computing device of FIG. 8.

As noted, when it is described herein that the clearinghouse system 150 may perform an action, it should be understood that the action may in turn be performed by the hardware components from which the clearinghouse system 150 is composed; similarly, when it is described herein the clearinghouse system 150 is configured in a given manner and/or possesses a given attribute, it should be understood that the hardware components from which the clearinghouse system 150 is composed are configured in the given manner and/or possesses the given attribute. To further elaborate on this, in various embodiments, one or more of the following may apply:

(a) When it is described herein that the clearinghouse system 150 may perform an action, the action may be performed by one or more of the transaction servers 760 or by one or more of the transaction servers 760 in conjunction with the networking equipment 770, and/or storage systems 780. In an embodiment wherein one or more of the transaction servers 760 is implemented as the computing device 800 of FIG. 8, any action described herein as performed by the clearinghouse system 150 may in turn be performed by the processor 802 or by the processor 802 in conjunction with the network interface device 804, the storage device 806, and/or the memory device 808, as appropriate.

(b) Whenever it is described herein that the clearinghouse system 150 handles, stores, analyzes, or otherwise processes data of any kind, the data may be handled, stored, analyzed, or otherwise processed by one or more of the transaction servers 760. In an embodiment where one or more of the transaction servers 760 is implemented as the computing device 800, any data that is handled, stored, analyzed, or otherwise processed by one or more of the transaction servers 760 may in turn be handled, stored, analyzed, or otherwise processed by the processor 802 or by the processor 802 in conjunction with the network interface device 804, the storage device 806, and/or the memory device 808, as appropriate.

(c) Whenever it is described herein that the clearinghouse system 150 transmits or receives data of any kind, the data may be transmitted/received by one or more of the transaction servers 760, in conjunction with the networking equipment 170; and in an embodiment where one or more of the transaction servers 760 is implemented as the computing device 800, the data may be transmitted/received by the computing device 800 via the network interface device 804 in conjunction with the processor 802, as appropriate.

(d) In an embodiment where one or more of the transaction servers 760 is implemented as the computing device 800, the storage device 806 and/or the memory device 808 may store instructions which, when executed by the processor 802: (i) cause the processor 802 to perform any action or combination of actions described herein as performed by the clearinghouse system 150; or (ii) cause the processor 802 to perform any action or combination of actions described herein as performed by the clearinghouse system 150, in conjunction with the network interface device 804, storage device 806, and/or memory device 808, as appropriate.

(e) Whenever it is described herein that the clearinghouse system 150 handles, stores, analyzes, or otherwise processes data of any kind, the data may be stored by one or more of the storage systems 780.

Alternatively or additionally, in some embodiments, one or more of the trading terminals 110 may be implemented using the computing device 800 of FIG. 8. In such an embodiment, one or more of the following may apply:

(a) Any action described herein as performed by one of the trading terminals 110 may in turn be performed by the processor 802 or by the processor 802 in conjunction with the network interface device 804, the storage device 806, and/or the memory device 808, as appropriate.

(b) Whenever it is described herein that one of the trading terminals 110 handles, stores, analyzes, or otherwise processes data of any kind, the data may be handled, stored, analyzed, or otherwise processed by the processor 802 or by the processor 802 in conjunction with the network interface device 804, the storage device 806, and/or the memory device 808, as appropriate.

(c) Whenever it is described herein that one of the trading terminals 110 transmits or receives data of any kind, the data transmitted/received by the trading terminal via the network interface device 804 in conjunction with the processor 802, as appropriate.

(d) In an embodiment where one or more of the trading terminals 110 is implemented as the computing device 800, the storage device 806 and/or the memory device 808 may store instructions which, when executed by the processor 802: (i) cause the processor 802 to perform any action or combination of actions described herein as performed by one of the trading terminals 110; or (ii) cause the processor 802 to perform any action or combination of actions described herein as performed by the trading terminals 110, in conjunction with the network interface device 804, storage device 806, and/or memory device 808, as appropriate.

### Further Applications of Described Concepts

Although examples are provided above with respect to specific YLPD IRS futures and PLPD IRS futures, it should be understood that the features described herein may be used, mutatis mutandis, with any type or types of financial instruments, including but not limited to different types of IRSs, futures, options, equities, and/or other types of financial instruments.

As described above, with YLPD IRS futures and PLPD IRS futures, the holder of the “long” position receives payments under the IRS at the fixed rate and the holder of the “short” position receives payments at the floating rate; however, in other embodiments, this nomenclature may be reversed—i.e., in other embodiments, all of the features described above with reference to FIG. 1 through FIG. 8 may be performed, where the holder of the long position receives payments under the floating rate and the holder of the short position receives payments under the fixed rate.

Although various embodiments have been shown and described in detail, the claims are not limited to any particular embodiment or example. None of the above description should be read as implying that any particular element, step, range, or function is essential. All structural and functional equivalents to the elements of the above-described preferred embodiment that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, component, or step in this specification is intended to be dedicated to the public.

Although features and elements are described herein in particular combinations, each feature or element can be used alone or in any combination with or without the other features and elements. For example, each feature or element as described above with reference to FIG. 1 through FIG. 8 may be used alone without the other features and elements or in various combinations with or without other features and elements. Sub-elements of the methods and features described above with reference to FIG. 1 through FIG. 8 may be performed in any arbitrary order (including concurrently), in any combination or sub-combination.

1. A method, comprising:
at a clearinghouse computing system, wherein the clearinghouse computing system includes a processor, a network interface device, and a memory device, performing actions that include:
receiving, at the network interface device and via one or more communication networks, one or more electronic data messages that include information regarding an interest rate swap (IRS) futures contract between a first party and a second party, wherein:
the IRS futures contract is a contract for an IRS future;
the IRS futures contract specifies an IRS that includes a fixed leg that has a fixed interest rate and a floating leg has a floating interest rate, such that, during the IRS, the first party will pay the second party according to the fixed interest rate and the second party will pay the first party according to the floating interest rate;
the fixed interest rate has not been set; and
the information regarding the IRS futures contract indicates:
an identifier for the first party;
an identifier for the second party;
a yield for the IRS futures contract; and
a delivery date at which the IRS will begin;
storing, at the memory device, the received information regarding the IRS futures contract; and
at the delivery date:
receiving, at the network interface device and via the one or more communication networks, one or more electronic data messages that indicate a current benchmark yield for the IRS future;
setting, at the memory device, the fixed interest rate to be equal to the current benchmark yield; and
storing, at the memory device, information that indicates that the IRS has been delivered.

2. The method of claim 1, further comprising:
at an exchange computing system:
prior to the receiving the information regarding the IRS futures contract:
receiving a first electronic data message, the first electronic data message indicating a long order from the first party for the IRS futures contract and including a first yield parameter;
receiving a second electronic data message, the second electronic data message indicating a short order from the second party for the IRS futures contract and including a second yield parameter;
determining that the long order from the first party and the short order match from the second party match based on the first yield parameter and the second yield parameter; and
transmitting the information regarding the IRS futures contract to the clearinghouse computing system.

3. The method of claim 1, further comprising:
at the clearinghouse computing system:
after the storing the received information regarding the IRS futures contract and prior to the delivery date:
determining profit and loss for the IRS futures contract based on:
the yield for the IRS futures contract;
current benchmark yield information;
a length of time until the delivery date; and
updating an account value for the first party according to the determined profit and loss; and
updating an account value for the second party according to the determined profit and loss.

4. The method of claim 1, wherein:
the one or more electronic data messages that indicate the current benchmark yield are received from an exchange computing system; and
the current benchmark yield is one of:
a yield at which the IRS future recently traded on the exchange computing system;
a yield for a current best short offer for the IRS future in an order book maintained by the exchange computing system; or
a yield for a current best long offer for the IRS future in the order book maintained by the exchange computing system.

5. The method of claim 1, wherein the IRS future is a yield-listed par-deliverable (YLPD) IRS future.

6. The method of claim 1, wherein the receiving the one or more electronic data messages includes receiving the one or more electronic data messages via one or more communication networks that include: a packet-switched network; an Ethernet network; a wireless local area network (WLAN); or a cellular network.

7. A computing system configured to implement clearinghouse functionality, the computing system comprising:
at least one processor;
at least one network interface device; and
at least one storage device;
wherein the at least one processor, at least one network interface device, and at least one storage device are configured to perform actions that include:
receiving one or more electronic data messages that include information regarding an interest rate swap (IRS) futures contract between a first party and a second party, wherein:
the IRS futures contract is a contract for an IRS future;
the IRS futures contract specifies an IRS that includes a fixed leg that has a fixed interest rate and a floating leg has a floating interest rate;
the fixed interest rate has been set to an initial fixed interest rate; and
the information regarding the IRS futures contract indicates:
a price for the IRS futures contract;
a notional value for the IRS futures contract; and
a delivery date at which the IRS will begin;
storing the received information regarding the IRS futures contract;
at the delivery date:
determining a present value for the floating leg;
determining an adjusted fixed interest rate such that, with the adjusted fixed interest rate, a present value of the fixed leg is equal to the determined present value for the floating leg;
setting the fixed interest rate equal to the determined adjusted fixed interest rate; and
adjusting the notional value for the IRS futures contract to offset against the change between the adjusted fixed interest rate and the initial fixed interest rate.

8. The computing system of claim 7, wherein, prior to the receiving the information regarding the IRS futures contract, the IRS futures contract was listed by an exchange computing system in terms of price.

9. The computing system of claim 7, wherein the actions further include:
after the storing the received information regarding the IRS futures contract and prior to the delivery date:
determining profit and loss for the IRS futures contract based on one or more of:
the price for the IRS futures contract;
current benchmark price information; or
a length of time until the delivery date;
updating an account value for the first party according to the determined profit and loss; and
updating an account value for the second party according to the determined profit and loss.

10. The computing system of claim 7, wherein the determining the present value for the floating leg includes determining the present value for the floating leg based on:
an overnight indexed swap (OIS) rate; and
a benchmark price for an interest rate futures contract, wherein the interest rate futures contract is one of: a sterling futures contract; a euro (EURIBOR) futures contract; or a eurodollar (LIBOR) futures contract.

11. The computing system of claim 7, wherein the IRS future is a price-listed par-deliverable (PLPD) IRS future.

12. The computing system of claim 7, wherein the receiving the one or more electronic data messages includes receiving the one or more electronic data messages via one or more communication networks that include: a packet-switched network; an Ethernet network; a wireless local area network (WLAN); or a cellular network.

13. A non-transitory computer-readable medium having instructions stored thereon which, when executed by at least processor that is included in a computing system that includes the least one processor, at least one network interface device, and at least one memory device, cause the computing system to perform actions that include:
receiving, via the network interface device, one or more electronic data messages that include information regarding an interest rate swap (IRS) futures contract between a first party and a second party, wherein:
the IRS futures contract specifies an IRS that has a fixed interest rate and a floating interest rate;
the information regarding the IRS futures contract includes information indicating a delivery date at which the IRS will begin;
storing, in the memory device, the received information regarding the IRS futures contract; and
setting, by the processor at the delivery date, the fixed interest rate such that the IRS is at par value.

14. The non-transitory computer-readable medium of claim 13, wherein, prior to the receiving the information regarding the IRS futures contract, the IRS futures contract was listed by an exchange computing system in terms of yield.

15. The non-transitory computer-readable medium of claim 13, wherein, prior to the receiving the information regarding the IRS futures contract, the IRS futures contract was listed by an exchange computing system in terms of price.

16. The non-transitory computer-readable medium of claim 13, wherein the actions further include:
prior to the delivery date:
determining profit and loss for the IRS futures contract based on a length of time until the delivery date;
updating an account value for the first party according to the determined profit and loss; and
updating an account value for the second party according to the determined profit and loss.

17. The non-transitory computer-readable medium of claim 13, wherein the IRS futures contract is a yield-listed par-deliverable (YLPD) IRS futures contract.

18. The non-transitory computer-readable medium of claim 13, wherein the IRS futures contract is a price-listed par-deliverable (PLPD) IRS futures contract.

19. The non-transitory computer-readable medium of claim 13, wherein the receiving the one or more electronic data messages includes receiving the one or more electronic data messages via one or more communication networks that include: a packet-switched network; an Ethernet network; a wireless local area network (WLAN); or a cellular network.
